(19) United States
(12) Patent Application Publication
(10) Pub. No.: US 2016/0035122 A1
(43) Pub. Date: Feb. 4, 2016

(54) Visual Function Targeting Using Varying Contrasting Areas

(71) Applicants: Charles W. Stewart, Laguna Beach, CA (US); Allan N. Hytowitz, Alpharetta, GA (US)

(72) Inventors: Charles W. Stewart, Laguna Beach, CA (US); Allan N. Hytowitz, Alpharetta, GA (US)

(21) Appl. No.: 14/447,794

(22) Filed: Jul. 31, 2014

(51) Int. Cl. G06T 13/80; G06T 7/00; G06T 7/20

(52) U.S. Cl. CPC G06T 13/80; G06T 7/2033; G06T 7/0042

(57) ABSTRACT

A solution for targeting a visual function using varying contrasting areas is provided. An animation including a changing figure can be generated. The changing figure can include contrasting areas having attributes that change substantially continually during the animation. For example, a location of the contrasting areas within the changing figure can be changed to create an appearance of motion of the contrasting areas within the changing figure. The shape attributes can be determined based on a target visual function, a target performance level of the target visual function, and a plurality of display attributes of a display environment for an observer. The animation can be provided for display to the observer, and an indication of whether the observer is able to perceive the changes can be received and used to assess a performance level of the visual function.

### TECHNICAL FIELD

The disclosure relates generally to visual assessment, and more particularly, to assessing one or more visual functions using moving contrasting areas.

### BACKGROUND ART

Visual acuity is clearness of vision, and is defined as an ability to perceive or resolve a linear minimum angle of separation or “Minimum Angle of Resolution” between two stationary lines or points. Historical measures of visual acuity are defined and tested using unmoving or static optotypes. The optotypes are generally composed of static high contrast, black letters or pictograms on a white background, or the converse, and are generally commonly recognized characters or shapes. Illustrative sets of optotypes include Snellen letters, Sloan letters and numbers, Landolt C's, Tumbling E's, and pictograms (typically used with illiterate individuals and children).

The human eye's neuro-biologic function that produces visual sensation fundamentally requires changes in light stimulus on a given retinal area rather than strictly resolving static differentiation of two points. A classical demonstration of this phenomena has been described by various researchers using an image that was mechanically stabilized, i.e. not moving on the retina, resulting in the image fully fading and no longer visible within a few seconds. As another example, Troxler's Fading also demonstrates the importance of visual stimuli area movement showing that visual stimuli that do not change position, or move, rapidly no longer are visually perceived. These retinal stabilization experiments demonstrate that the human visual system has evolved to optimally detect changes in stimulation and motion, which is not directly the primary feature tested using historical visual acuity testing methods.

In addition to visual acuity, historical assessment of other visual functions such as contrast sensitivity, color vision, refraction, and perception of distance and depth, commonly utilize static targets in which a subject is requested to correctly identify optotypes (e.g., text, numbers, or pictograms) to arrive at a confusion point defining the perceptual threshold for the corresponding visual function.

A previously described vision test includes at least one animated dynamic optotype image shape for measuring the visual acuity of a subject. The animated dynamic optotype is described as a rotating image with a linear gap width, which can be scaled in size in such a way as to test vision in a manner that compares directly to the distance and acuity scale of previous vision tests.

### SUMMARY OF THE INVENTION

An advanced testing method in which various aspects of vision performance can assessed leveraging the innate features of the vision system's stimulus varying requirement is herein described. Aspects of the invention provide a solution for targeting a visual function using varying contrasting areas. An animation including a changing figure can be generated. The changing figure can include contrasting areas having attributes that change substantially continually during the animation. For example, a location of the contrasting areas within the changing figure can be changed to create an appearance of motion of the contrasting areas within the changing figure. The shape attributes can be determined based on a target visual function, a target performance level of the target visual function, and a plurality of display attributes of a display environment for an observer. The animation can be provided for display to the observer, and an indication of whether the observer is able to perceive the changes can be received and used to assess a performance level of the visual function.

A first aspect of the invention provides a method comprising: determining a plurality of shape attributes for a changing figure based on a target visual function, a target performance level of the target visual function, and a plurality of display attributes of a display environment for an observer, wherein the changing figure includes a plurality of contrasting areas; generating an animation including the changing figure, wherein the generating includes varying the plurality of contrasting areas during the animation to create a substantially continuously changing figure; and providing the animation for display to the observer.

A second aspect of the invention provides a system comprising: a computer system including at least one computing device, wherein the computer system performs a process for assessing a target visual function including: determining a plurality of shape attributes for a changing figure based on the target visual function, a target performance level of the target visual function, and a plurality of display attributes of a display environment for an observer, wherein the changing figure includes a plurality of contrasting areas; generating an animation including the changing figure, wherein the generating includes varying the plurality of contrasting areas during the animation to create a substantially continuously changing figure; and providing the animation for display to the observer.

A third aspect of the invention provides a method comprising: determining a plurality of shape attributes for a changing figure based on a target visual function, a target performance level of the target visual function, and a plurality of display attributes of a display environment for an observer; generating an animation including the changing figure, wherein the generating includes creating an appearance of motion within the changing figure, and wherein the changing figure comprises a rectangular shape; and providing the animation for display to the observer.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for assessing a performance level of a patient with respect to one or more visual functions according to an embodiment.

FIGS. 2A and 2B show illustrative targeting interfaces according to embodiments.

FIG. 3 shows an illustrative ring-shaped figure according to an embodiment.

FIG. 4 shows an illustrative representation of a retinal area of a patient with the figure shown in FIG. 3 and a static figure superimposed thereon according to an embodiment.

FIG. 5 shows a series of illustrative representations of a retinal area of a patient with several frames of an animation including the figure shown in FIG. 3 superimposed thereon according to an embodiment.

FIGS. 6A-6D show illustrative geometric figures according to embodiments.

FIGS. 7A-7C show illustrative targeting interfaces including illustrative arrangements of multiple figures according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for targeting a visual function using varying contrasting areas. An animation including a changing figure can be generated. The changing figure can include contrasting areas having attributes that change substantially continually during the animation. For example, a location of the contrasting areas within the changing figure can be changed to create an appearance of motion of the contrasting areas within the changing figure. The shape attributes can be determined based on a target visual function, a target performance level of the target visual function, and a plurality of display attributes of a display environment for an observer. The animation can be provided for display to the observer, and an indication of whether the observer is able to perceive the changes can be received and used to assess a performance level of the visual function. As used herein, unless otherwise noted, the term “set” means one or more (i.e., at least one) and the phrase “any solution” means any now known or later developed solution.

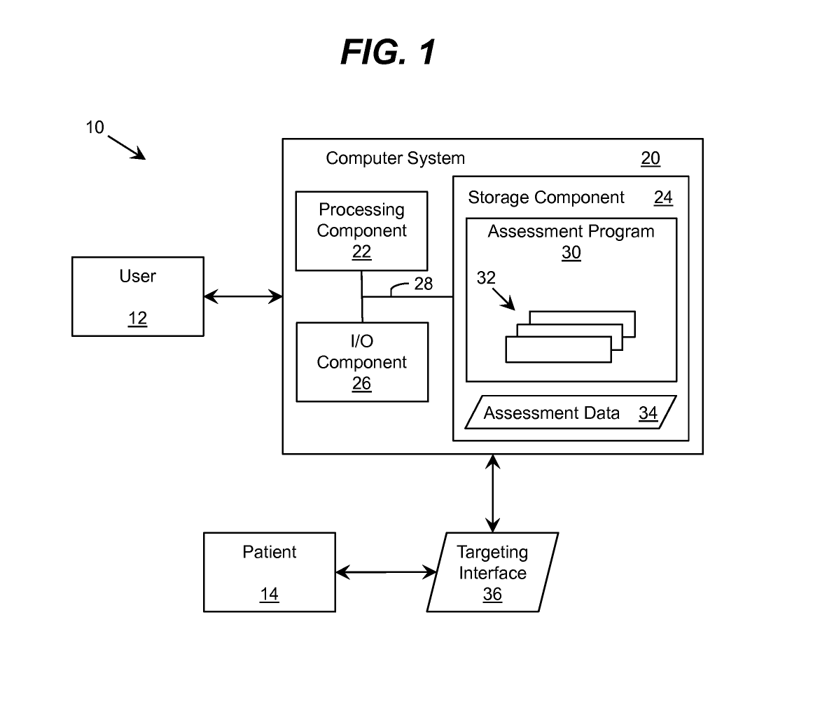

Turning to the drawings, FIG. 1 shows an illustrative environment 10 for assessing a performance level of a patient 14 with respect to one or more visual functions according to an embodiment. To this extent, the environment 10 includes a computer system 20 that can perform a process described herein in order to assess the performance level of the patient 14 with respect to a visual function. In particular, the computer system 20 is shown including an assessment program 30, which makes the computer system 20 operable to assess the performance level of the patient 14 with respect to the visual function(s) by performing a process described herein.

The computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, the processing component 22 executes program code, such as the assessment program 30, which is at least partially fixed in storage component 24. While executing program code, the processing component 22 can process data, which can result in reading and/or writing transformed data from/to the storage component 24 and/or the I/O component 26 for further processing. The pathway 28 provides a communications link between each of the components in the computer system 20. The I/O component 26 can comprise one or more human I/O devices, which enable a human user 12 to interact with the computer system 20 and/or one or more communications devices to enable a system user 12 to communicate with the computer system 20 using any type of communications link. To this extent, the assessment program 30 can manage a set of interfaces (e.g., graphical user interface(s), application program interface, and/or the like) that enable human and/or system users 12 to interact with the assessment program 30. Furthermore, the assessment program 30 can manage (e.g., store, retrieve, create, manipulate, organize, present, etc.) the data, such as assessment data 34, using any solution.

In any event, the computer system 20 can comprise one or more general purpose computing articles of manufacture (e.g., computing devices) capable of executing program code, such as the assessment program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the assessment program 30 can be embodied as any combination of system software and/or application software.

Furthermore, the assessment program 30 can be implemented using a set of modules 32. In this case, a module 32 can enable the computer system 20 to perform a set of tasks used by the assessment program 30, and can be separately developed and/or implemented apart from other portions of the assessment program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 20.

When the computer system 20 comprises multiple computing devices, each computing device can have only a portion of the assessment program 30 fixed thereon (e.g., one or more modules 32). However, it is understood that the computer system 20 and the assessment program 30 are only representative of various possible equivalent computer systems that may perform a process described herein. To this extent, in other embodiments, the functionality provided by the computer system 20 and the assessment program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 20 includes multiple computing devices, the computing devices can communicate over any type of communications link. Furthermore, while performing a process described herein, the computer system 20 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

To this extent, the user 12 and/or the patient 14 can be a computer system, either of which also can be a general purpose computer system as described herein in conjunction with the computer system 20. When the user 12 and/or the patient 14 is a computer system, the computer system 20 can generate a user interface, such as a graphical user interface, for presentation to an individual utilizing the user 12 and/or the patient 14. Alternatively, the user 12 and/or the patient 14 can be an individual. In this case, the computer system 20 can generate and present the user interface to the user 12 and/or the patient 14. In either case, the user 12 and patient 14 can be different computer systems/individuals or the same computer system/individual. More particular illustrative environments 10 include: a visual assessment system (e.g., including an interface for providing a controlled viewing environment); a desktop/laptop computing device; a tablet computing device; a computing device communicating to a server over a network, such as the Internet, and/or the like.

As described herein, the computer system 20 can assess a performance level of a patient 14 with respect to one or more visual functions. It is understood that the patient 14 can be a human or other animal for which one or more visual functions are to be assessed. The assessment can be performed in a medical environment, such as a physician's office, an optometrist's office, and/or the like, or in any environment selected by the patient 14, such as his/her home, office, and/or the like. In an embodiment, some or all of the assessment is performed by a professional, such as a user 12 who is a medical practitioner (general practice or specialist), an optometrist, and/or the like. In an alternative embodiment, the assessment is self-administered by the patient 14. Regardless, when the user 12, such as a professional, is different from the patient 14, it is understood that the user 12 and patient 14 can be at the same location or remotely located from one another.

As discussed herein, the assessment program 30 enables the computer system 20 to assess a performance level of the patient 14 with respect to one or more visual functions. To this extent, the computer system 20 can generate a targeting interface 36 for presentation to a patient 14. The targeting interface 36 can include one or more figures which are individually and/or collectively configured to target one or more visual functions of the patient 14. The computer system 20 can use the targeting interface 36 to receive an indication corresponding to an ability of the patient 14 to perceive one or more features present in the targeting interface 36. The indication can be used, e.g., by the computer system 20 and/or the user 12, to assess the performance level of the patient 14 with respect to the visual function(s).

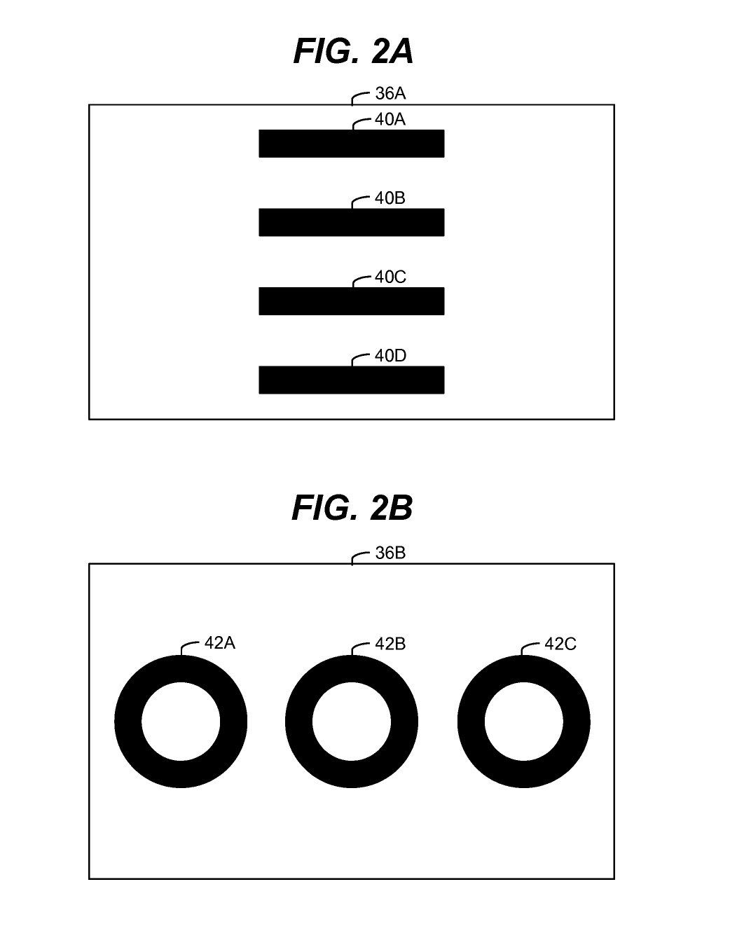

FIGS. 2A and 2B show illustrative targeting interfaces 36A, 36B, respectively, according to embodiments. Referring to FIGS. 1-2B, each targeting interface 36A, 36B is shown including a plurality of figures, which the computer system 20 can configure to target one or more visual functions of a patient 14, e.g., as part of an assessment of a performance level of the patient 14 for the targeted visual function(s) being performed by/using the computer system 20. Each figure can be a geometric figure having any attributes including: linear or curvilinear, periodic or aperiodic, and/or the like. In FIG. 2A, the targeting interface 36A is shown including a plurality of FIGS. 40A-40D, each of which is defined by a substantially rectangular border. In FIG. 2B, the targeting interface 36B is shown including a plurality of FIGS. 42A-42D, each of which is defined by a pair of concentric elliptical (e.g., circular) borders. While each targeting interface 36A, 36B is shown having a particular number, type, and arrangement of figures, it is understood that these targeting interfaces 36A, 36B are only illustrative of various configurations of a targeting interface 36, which can be utilized as described herein. To this extent, in other embodiments, a targeting interface 36 can include any number of one or more figures, any combination of one or more types of figures, and any arrangement of the figure(s) within a display area of the targeting interface 36.

The computer system 20 can determine the shape attributes for one or more of the FIGS. 40A-40D, 42A-42D in the targeting interfaces 36A, 36B based on the target visual function(s), a target performance level for each of the target visual function(s), and/or display attributes of a display environment in which the patient 14 will view the targeting interface 36A, 36B. Illustrative visual functions which can be targeted include: visual acuity, dynamic visual acuity, refraction, distance detection, visual size differentiation, motion detection, color detection, color sensitivity, contrast sensitivity, and/or the like. The target performance level for a visual function can be quantified using any solution. In an embodiment, the computer system 20 can use a default target performance level, which corresponds to an average performance level (e.g., 20/20 (feet) or 6/6 (meters) vision for the visual acuity), a minimum performance level (e.g., a minimum visual acuity for driving or reading), a performance level specified by the user 12, and/or the like.

The computer system 20 can obtain the display attributes of the display environment using any solution. For example, the computer system 20 can use a default set of display attributes of a typical or known display environment. Illustrative display attributes can include one or more of: a distance from a display screen, a viewing angle of the patient 14 to the display screen, ambient lighting in the display environment, a size of the display screen, a resolution of the display screen, and/or the like. Furthermore, the computer system 20 can enable the user 12 and/or the patient 14 to alter one or more of the display attributes using any solution. For example, the computer system 20 can generate a user interface, which when presented to the user 12 and/or the patient 14, enables selection and alteration of one or more of the display attributes. In an embodiment, the computer system 20 can receive video input data of the patient 14 at the location at which the shapes will be viewed from a camera having a known orientation with respect to the display screen. The computer system 20 can determine one or more of the display attributes by processing the video input data using any solution.

Once the target visual function(s), a target performance level for each of the target visual function(s), and/or display attributes of the display environment are available, the computer system 20 can determine the shape attributes of a figure to be displayed to the patient 14 using any solution. For example, depending on the target visual function(s), the computer system 20 can adjust one or more of: a color of a feature in the figure and/or the background, a contrast between two or more features in the figure and/or between the figure and the background, a size of the figure in the targeting interface, a relative size between features in the figure, and/or the like. The computer system 20 can calculate the appropriate shape attributes using any solution. For example, to evaluate visual acuity of a patient 14, the computer system 20 can calculate shape attributes such that a size of the figure perceived by the patient 14 corresponds to a size utilized for a corresponding visual acuity used in a Snellen chart or other mechanism for evaluating visual acuity. In an embodiment, the computer system 20 can derive one or more of the shape attributes empirically, e.g., by repeatedly generating and observing perceptions using patients 14 with known performance level(s) for the target visual function(s).

In an embodiment, one or more of the FIGS. 40A-40D, 42A-42D in the targeting interfaces 36A, 36B can include a plurality of contrasting areas. In an embodiment, the contrasting areas are scalable, geometric or amorphous, non-literate areas. A FIG. 40A-40D, 42A-42D can include contrasting areas that are arranged in a periodic or aperiodic manner. Furthermore, when presented to the patient 14, the computer system 20 can generate an animation (e.g., a video) in which one or more of the shape attributes of a figure varies during the animation. For example, the computer system 20 can adjust one or more attributes of the contrasting areas of the figure. To this extent, the computer system 20 can vary the shape attribute(s) to create an appearance of a substantially continuously changing figure. As used herein, a substantially continuously changing figure is a figure in which the attribute(s) change from frame to frame in the animation (e.g., video) or change in groups of frames such that the figure will not be perceived as having fixed attributes for any significant period of time (e.g., a half of second) by a patient 14 capable of perceiving the changes. It is understood that the term “animation,” as used herein, is not limited to any particular type of technology for creating an appearance of motion (e.g., the changing figures described herein). To this extent, animation includes any solution for storing and generating a series of images or image-like depictions for presentation to an observer. In an embodiment, the animation comprises a video. As used herein, the term “video” encompasses all storage and presentation formats now known or later developed, which are capable of storing and presenting the changing figures described herein in a manner as described herein to an observer. Illustrative animation storage/generation solutions include: adjusting a display device using image data stored on a computer-readable medium; projecting a series of images (e.g., included in a film strip) onto a viewing surface; altering the on/off status of a series of lights arranged in a two-dimensional pattern; and/or the like.

In an embodiment, while the computer system 20 varies one or more attributes of the figure in the animation, a location and extent of the figure in the animation can be defined by a static border in the targeting interface 36A, 36B for a predefined period of time. In this case, a location and/or size of the figure within the display region will not be perceived to be changing by the patient 14. In another embodiment, the computer system 20 can vary a size of the figure, e.g., after the predefined period of time, which will cause the border defining the extent of the figure in the targeting interface 36A, 36B to change. For example, the size can be varied in a manner that the figure appears to be stationary, but getting larger as if a distance between the patient 14 and the figure is getting smaller. Alternatively, the computer system 20 can vary the relative size of one or more features of a figure with respect to the overall size of the figure. For example, the computer system 20 can adjust a diameter of the inner opening of the FIGS. 42A-42C while maintaining a constant outer diameter of the FIGS. 42A-42C.

The computer system 20 can vary the attributes of the figure in a manner that results in changes in light stimulus on a given retinal area of the patient 14. In an illustrative embodiment, the variation can be perceived as motion within the border of the figure by a patient 14 having a sufficient performance level for the corresponding target visual function. In another embodiment, the variation can be perceived as a pulsing within the border of the figure by such a patient. However, it is understood that motion and pulsing are only illustrative of various changes that the computer system 20 can simulate for the figure. Regardless, the shape attributes can include a velocity and/or acceleration of the variation within the border of the figure, as well as a velocity and/or acceleration of variation of a size of the figure in the targeting interface 36A, 36B, and/or the like.

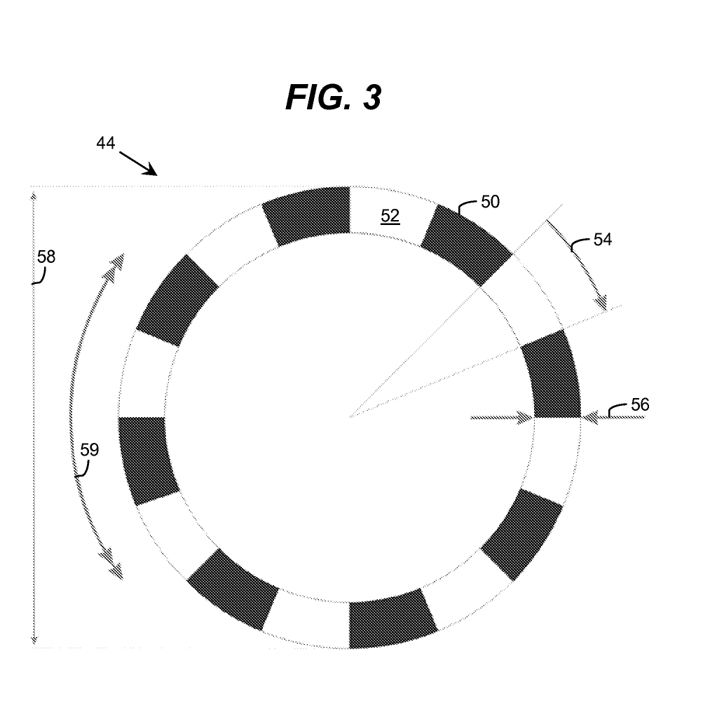

Additional details regarding varying the attributes of one or more of the FIGS. 40A-40D, 42A-42D in the targeting interfaces 36A, 36B are discussed in conjunction with illustrative figures. For example, FIG. 3 shows an illustrative ring-shaped FIG. 44 according to an embodiment. It is understood that while a ring-shaped FIG. 44 is shown, any type of linear or curvilinear figure can be utilized. The ring-shaped FIG. 44 includes a plurality of contrasting areas, which are defined as two groups of contrasting areas 50, 52 of the ring-shaped FIG. 44 with alternating colors (e.g., black areas 50 and white areas 52). As described herein, the contrasting areas can be geometric (as shown in FIG. 3) or amorphous.

The colors of the groups of contrasting areas 50, 52 can be selected to provide a desired contrast between the groups of contrasting areas 50, 52 and between each group of contrasting areas 50, 52 and the corresponding background color of a targeting interface 36 (FIG. 1) on which the FIG. 44 is presented. In an embodiment, a color of one or more of the groups of contrasting areas 50, 52 can correspond to the background color. Alternatively, the colors of all groups of contrasting areas 50, 52 can differ from the background color. As illustrated, the contrasting areas 50, 52 can have corresponding visual angles 54 and visual arc-widths 56, which are substantially equal for the groups of contrasting areas 50, 52. Additionally, the visual angle 54 and visual arc-width 56 of a contrasting area 50, 52 can be used to calculate a visual arc-area (e.g., expressed in arcseconds²) for the contrasting area 50, 52, which can be substantially equal for each of the contrasting areas 50, 52. Alternatively, contrasting areas of the same color can have a visual angle 54 and/or a visual arc-width 56 that differs from that of the contrasting areas of the other color. Furthermore, it is understood that the FIG. 44 can include contrasting areas 50, 52 having any combination of numerous varying attributes. While a FIG. 44 including contrasting areas 50, 52 of two colors is illustrated, it is understood that a FIG. 44 can include contrasting areas of any number of varying colors.

The computer system 20 (FIG. 1) can vary one or more attributes of the contrasting areas 50, 52 to create an animation including changing FIG. 44. In an embodiment, the computer system 20 generates an animation in which the locations of each of the contrasting areas 50, 52 in the FIG. 44 appears to be substantially continuously changing. For example, the computer system 20 can generate an animation in which the contrasting areas 50, 52 appear to be moving clockwise or counterclockwise with a pre-determined angular velocity 59 and/or acceleration. In this case, as described herein, the computer system 20 can determine the shape attributes for the FIG. 44 based on a target performance level for a target visual function. For example, the computer system 20 can select one or more of a total visual angle 58, a visual angle 54, a visual arc-width 56, a visual arc-area, contrasting area colors, angular velocity 59, and/or the like, such that a patient 14 having a target performance level for a target visual function will be able to perceive the changes in the FIG. 44, while a patient 14 having a performance level for the target visual function less than the target performance level will not be able to perceive the changes in the FIG. 44 (e.g., will only perceive a ring-shaped figure).

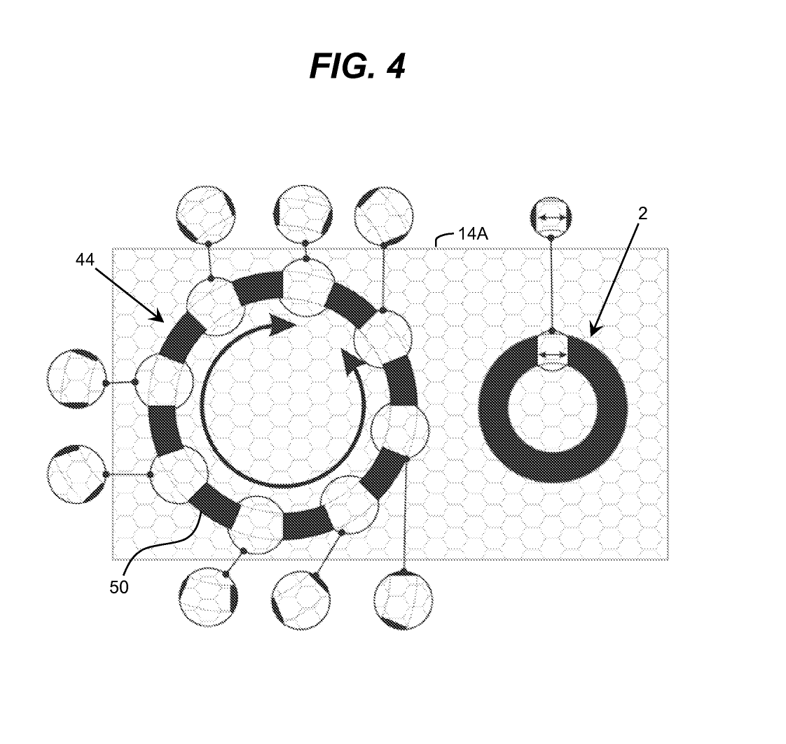

The computer system 20 (FIG. 1) can correlate a size of a contrasting area presented on a display device with a visual arc-area of the patient 14 (FIG. 1) using any solution. For example, the computer system 20 can correlate the visual arc-width/height of the patient 14 with a number of horizontal/vertical pixels on the display device using a set of attributes of the display device (e.g., size and resolution) and a viewing distance between the display device and the patient 14. In an embodiment, the computer system 20 selects a visual arc-area for the contrasting areas based on a size of the retinal area of a patient 14 to be stimulated. Alternatively, the computer system 20 can determine a size of the retinal area of the patient 14 stimulated based on the size of contrasting area (and its corresponding visual arc-area). FIG. 4 shows an illustrative representation of a retinal area 14A of a patient 14 with the FIG. 44 and a static FIG. 2 superimposed thereon according to an embodiment. As illustrated by the arrows, the FIG. 44 can include contrasting areas 50 having an apparent clockwise or counterclockwise motion in the animation generated by the computer system 20. The visual arc-area and/or motion of the contrasting areas 50 can be configured to cause various retinal cells (e.g., photoreceptor cells or groups of photoreceptor cells as indicated by the hexagonal shapes of the retinal area 14A), to be dynamically stimulated with a strobic, changing stimulus, as indicated by the eight isolated portions shown in conjunction with the FIG. 44. In contrast, the static FIG. 2 will result in static stimulation of a fixed group of the retinal cells.

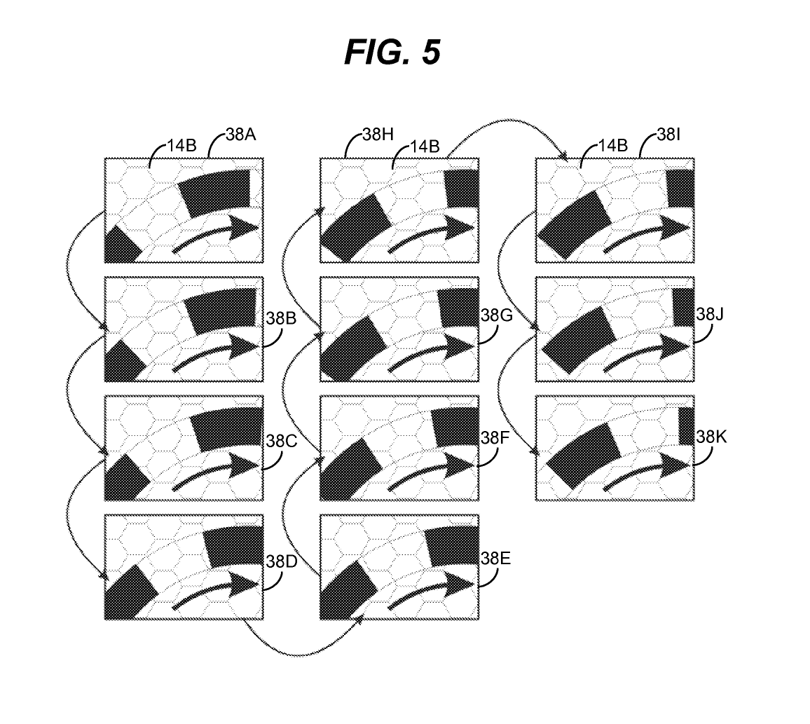

The changes in light stimulus on a given retinal area 14A of the patient 14 are further illustrated in FIG. 5, which shows a series of illustrative representations of a retinal area 14B of a patient 14 with several frames 38A-38K of an animation including the FIG. 44 superimposed thereon according to an embodiment. As illustrated, in adjacent frames 38A-38K in the series of frames 38A-38K, the positions of the contrasting areas 50, 52 (FIG. 3) are rotated clockwise from the positions of the visual stimulus contrasting areas 50, 52 in the previous frame 38A-38K. In this manner, when an animation including the frames 38A-38K is presented to the patient 14, a patient 14 will perceive the contrasting areas 50, 52 as moving clockwise when the patient 14 has a sufficient performance level for a target visual function. It is understood that by adjusting an amount with which the positions of the contrasting areas 50, 52 are changed between adjacent frames 38A-38K, the computer system 20 (FIG. 1) can adjust a velocity, acceleration, and/or direction of movement, which will be perceived by the patient 14.

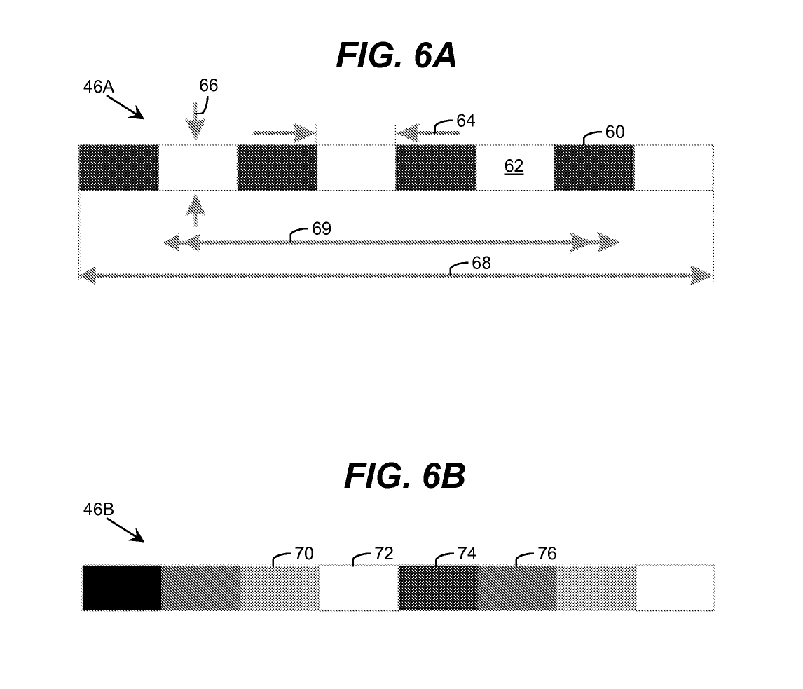

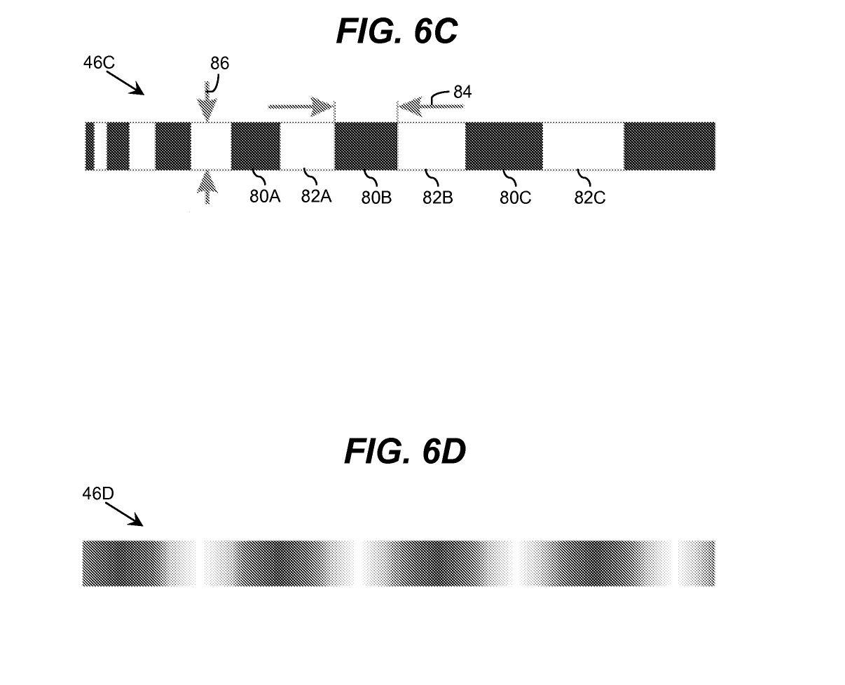

It is understood that simulated rotational movement in a curvilinear figure is only illustrative of various solutions for changing light stimulus on a given retinal area 14A, which can be implemented by the computer system 20. To this extent, FIGS. 6A-6B show illustrative rectangular FIGS. 46A-46D, respectively, according to embodiments. The computer system 20 can change attributes of the contrasting areas in the rectangular FIGS. 46A-46D to create an appearance of linear motion within the rectangular FIGS. 46A-46D.

As illustrated in FIG. 6A, the rectangular FIG. 46A includes a plurality of contrasting areas, which include two groups of contrasting areas 60, 62 of the rectangular FIG. 46A with alternating colors (e.g., black contrasting areas 60 and white contrasting areas 62). The colors of the groups of contrasting areas 60, 62 can be selected to provide a desired contrast between the groups of contrasting areas 60, 62 and between each group of contrasting areas 60, 62 and the corresponding background color of a targeting interface 36 (FIG. 1) on which the FIG. 46A is presented. In an embodiment, a color of one or more of the groups of contrasting areas 60, 62 can correspond to the background color. Alternatively, the colors of all groups of contrasting areas 60, 62 can differ from the background color. As illustrated, the contrasting areas 60, 62 can have corresponding visual arc areas, e.g., defined by visual angles 64 and visual arc-widths 66, which are substantially equal for the groups of contrasting areas 60, 62. Additionally, the visual angle 64 and visual arc-width 66 of a contrasting area 60, 62 can be used to derive a visual arc-area for the contrasting area 60, 62, which can be substantially equal for each of the contrasting areas 60, 62. Alternatively, contrasting areas of the same color can have a visual angle 64 and/or a visual arc-width 66 that differs from that of the contrasting areas of the other color. Furthermore, it is understood that the FIG. 46A can include contrasting areas 60, 62 having any combination of numerous varying attributes.

As described herein, a figure can include contrasting areas of any number of colors/contrasts. To this extent, FIG. 6B shows an illustrative rectangular FIG. 46B according to an embodiment, which includes alternating contrasting areas 70, 72, 74, 76 of four different colors/contrasts. Additionally, as described herein, a figure can include contrasting areas with differing visual angles, visual arc-widths, and/or the like. To this extent, FIG. 6C shows an illustrative rectangular FIG. 46C according to another embodiment, which includes contrasting areas 80A-80C, 82A-82C with differing visual angles 84 and therefore differing visual arc areas. While differing visual angles 84 and similar visual arc-widths 86 are illustrated, it is understood that this is only illustrative, and differing visual arc-widths 86 can be utilized in addition or in alternative to the differing visual angles 84.

Similarly, it is understood that a figure including contrasting areas with defined visual angles, visual arc-widths, and visual arc-areas is only illustrative of various types of approaches that can be used to create contrasting areas within the figure. For example, FIG. 6D shows an illustrative rectangular FIG. 46C according to an embodiment, in which the figure includes a substantially continually (e.g., having no clearly defined, perceivable areas of a given color) graded variation between two extent colors (e.g., white and black). The grading can be generated using any solution, such as sinusoidal, Gaussian blur, and/or the like. It is understood that the grading along a lateral extent of the rectangular FIG. 46C is only illustrative, and a figure can include vertical grading in addition or alternative to the lateral grading. Furthermore, it is understood that the distances between the two extent colors (at which point the grading transitions from getting lighter to getting darker or vice versa) is only illustrative, and any distance, or combination of two or more distances, can be utilized.

In an embodiment, the computer system 20 (FIG. 1) generates an animation including a FIG. 46A-46D, in which one or more features of the FIG. 46A-46D appears to be substantially continuously changing in order to change light stimulus on a given retinal area of a patient 14 (FIG. 1). For example, the computer system 20 can generate an animation in which the contrasting areas of FIGS. 46A-46C appear to be moving right or left with a pre-determined velocity and/or acceleration. Similarly, the computer system 20 can generate an animation in which the locations of the extent colors in FIG. 46D appear to be moving right or left with a pre-determined velocity and/or acceleration.

In this case, as described herein, the computer system 20 can determine the shape attributes for the FIG. 46A-46D, including the visual arc area used for the contrasting areas of the FIG. 46A-46D, based on a target performance level for a target visual function. For example, the computer system 20 can select one or more of a total visual angle, a visual angle, a visual arc-width, a visual arc area for each contrasting area, contrasting area colors, velocity, and/or the like, such that a patient 14 having a target performance level for a target visual function will be able to perceive the changes in the FIG. 46A-46D, while a patient 14 having a performance level for the target visual function less than the target performance level will not be able to perceive the changes in the FIG. 46A-46D (e.g., will only perceive a rectangular figure).

It is understood that the use of apparent motion within a figure is only illustrative of numerous types of variations of shape attributes, which the computer system 20 (FIG. 1) can utilize to create a substantially continuously changing figure, which changes a light stimulus on a given retinal area of a patient 14 (FIG. 1). For example, in another embodiment, the computer system 20 can vary one or more shape attributes to create a pulsing appearance (e.g., by gradually changing a color of a contrasting area between two extent colors during the animation) within the figure. Furthermore, the computer system 20 can vary one or more shape attributes to create a sparkling appearance (e.g., by temporarily changing the color of areas in a random or pseudo-random manner) within the figure.

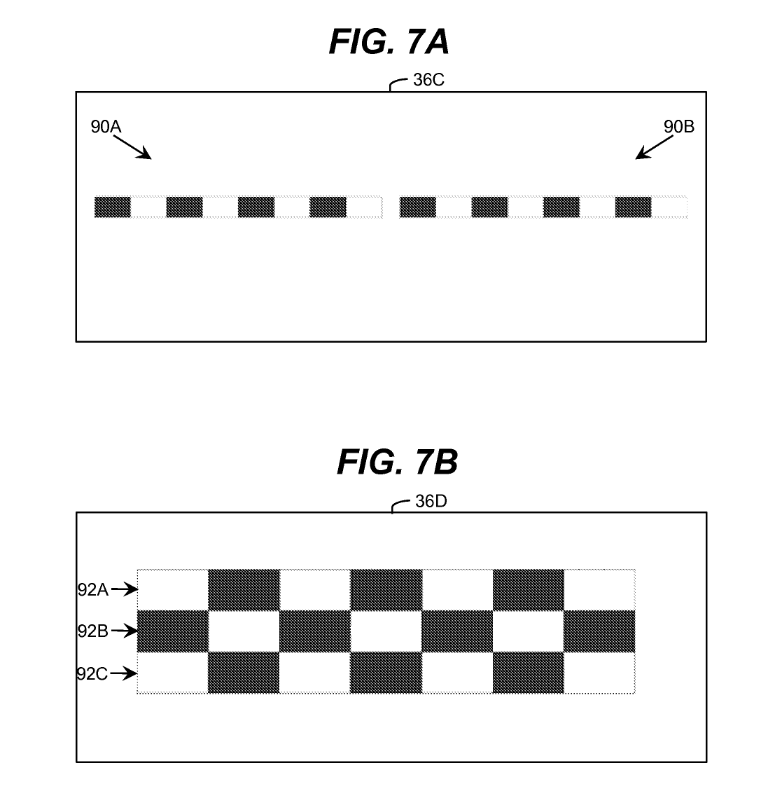

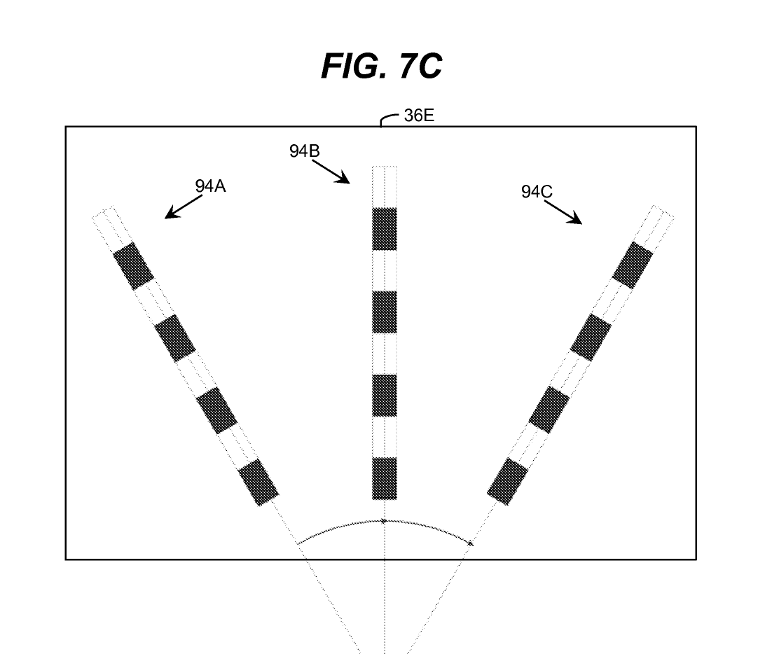

As described herein, the computer system 20 can generate a targeting interface, such as the targeting interfaces 36A, 36B shown in FIGS. 2A-2B, which includes multiple figures. To this extent, FIGS. 7A-7C show illustrative targeting interfaces 36C-36D including illustrative arrangements of multiple figures according to embodiments. In FIG. 7A, the targeting interface 36C includes a pair of substantially similar rectangular FIGS. 90A, 90B located on the same lateral plane within the targeting interface 36C. In FIG. 7B, the targeting interface 36D includes a rectangular FIGS. 92A-92C stacked on one another to create a composite rectangular figure. In FIG. 7C, the targeting interface 36E includes three rectangular FIGS. 94A-94C with different angles of orientation.

When the targeting interface, such as the targeting interfaces 36A-36E, includes multiple figures, the figures can be of similar configurations or can have one or more attributes that differ. Furthermore, when generating an animation, the computer system 20 (FIG. 1) can create a substantially continuously changing figure from any combination of one or more of the figures. For example, using the targeting interface 36C shown in FIG. 7A as an example, the computer system 20 can generate an animation in which only one of the FIGS. 90A, 90B is changing, while the other FIG. 90A, 90B can provide a reference or comparative to the changing FIG. 90A, 90B. Additionally, when two or more figures in the same targeting interface are changing in the animation, the computer system 20 can use the same solution for changing the figures, different solutions for changing the figures, the same solution with different attributes (e.g., velocity or acceleration), and/or the like.

Returning to FIG. 1, as described herein, the computer system 20 can use a targeting interface 36 to assess a performance level of the patient 14 with respect to one or more visual functions. To this extent, the computer system 20 can generate an animation described herein for inclusion in the targeting interface 36 and presentation to the patient 14 using any solution.

Furthermore, the computer system 20 can receive an indication corresponding to an ability of the patient 14 to perceive the changes in the appearance of the figure(s) in the animation using any solution. For example, the targeting interface 36 can include an ability for the patient 14 and/or user 12 to enter the information using a user interface control (e.g., a button, or the like), which is subsequently received by the computer system 20. Similarly, the computer system 20 can receive and process an indication spoken by the patient 14 and/or the user 12. In an embodiment, the indication includes a perceived direction of movement (e.g., right/left, clockwise/counterclockwise, up/down, and/or the like) in the figure, which the computer system 20 can compare with the actual simulated movement for accuracy. Still further, the computer system 20 can receive video data including the eyes of the patient 14, and process the video data to determine when the patient 14 directs his/her attention to the figure(s) in the targeting interface 36 that are changing and correlate the patient's 14 change in attention with his/her ability to perceive the changes in the figure.

In an embodiment, the targeting interface 36 includes multiple figures, each having different feature sizes for use in assessing the target visual function(s) of the patient 14. In this case, the computer system 20 can receive an indication as to which of the figures the patient 14 can perceive the changes, and which of the figures do not appear to be changing. Similarly, in response to an indication that the patient 14 can or cannot perceive the changes in any figure(s) in the targeting interface 36, the computer system 20 can alter a size of the figure(s) and/or visual arc areas of the contrasting areas in the targeting interface 36 until receiving the opposite indication from the patient 14. The computer system 20 can repeat the process to more accurately identify the actual size of the figure(s) and/or visual arc areas of the contrasting areas required for the patient 14 to perceive the changes, which the computer system 20 can correlate with a performance level for the visual function using any solution. For example, the computer system 20 can correlate the visual arc areas of the contrasting areas with a size of the retinal area of the patient 14 that required stimulation in order to perceive the changes.

In an embodiment, the computer system 20 determines a minimum arc area in which the variation in the changing figure is perceived by the patient 14 for a color or group of colors, and correlates the minimum arc area with the individual sensitivity of one or more of the various types of retinal photoreceptors (e.g., cone types (red—L, green—M, blue—S), rod types, and/or the like) of the patient 14. In this case, the computer system 20 can assess sensitivity of perception of specific colors or combinations of colors by the patient 14 by measuring a minimum perceived arc area of the acuity end point for the corresponding color or combination of colors. In an embodiment, the computer system 20 can assess the sensitivity of perception for each color and/or contrast combination specific to retinal photoreceptor types or photoreceptor functional conditions of interest (e.g., each of the photoreceptor types). For example, for an image to be accurately perceived by a human patient 14 with 20/20 visual acuity at a viewing distance of approximately 6.1 meters (20 feet), the arc minute angular area required for the image can vary based on the foreground/background colors used to generate the image, which elicit individual and either similar or dissimilar thresholds per photoreceptor type or photoreceptor condition. As an example, differences in the acuity end-points for a green image and its background contrast compared to a red image and its background contrast can provide functional information regarding the relative distribution or relative function of the related photoreceptors of the patient 14.

Embodiments of the invention can be directed to solve an existing technical problem with assessing visual function(s) of a patient 14. For example, the traditional use of static letters or pictograms in assessing a visual function relies on an evaluation of a statistically meaningful number of errors, misidentifications, or confusions of the static letters or pictograms that are based upon linear, minimum angle of resolution made by the patient 14. In contrast, an embodiment of the invention can identify a perceptual threshold of the visual function(s) of a patient 14 using a binary “on or off” indication, which can be applied to assessing any of various visual functions (e.g., visual acuity, dynamic visual acuity, refraction, distance detection, visual size differentiation, motion, color detection, color sensitivity, contrast sensitivity, and/or the like).

By evaluating an ability to perceive movement of a plurality of calibrated, contrasting areas displayed over a significantly larger total area of retinal receptors, a more precise assessment of the visual function(s) can be made by the computer system 20 than that provided by the prior art. Additional advantages in using a changing shape as described herein as compared to detection of an angular separation of static points used with historical visual acuity testing can include: application to various aspects of visual function; higher precision; higher reproducibility over both time and from subject to subject; higher test time efficiency; less confusion of endpoints; insensitivity to cultural and literacy biases; and/or the like.

As part of an assessment, the computer system 20 can vary the visual arc-areas of a figure by one or more features to illicit details specific to a target visual function. The features can include: area size, velocity of motion (including no motion), acceleration, direction or directions of motion, relative contrast of adjacent areas, colors or relative colors of the adjacent areas, periodic frequency of the adjacent areas, and/or the like. The computer system 20 can control the variables to elicit an indication of whether the patient 14 observed either movement or no movement for the figure. The indication can be used, e.g., by the computer system 20, to assess: visual acuity; a precision of visual detection of velocity or relative velocities of a plurality of objects; refractive characteristics of the eye such as myopia, hyperopia, accommodation, or astigmatism amount or axis; visual contrast sensitivity; depth perception; color vision deficiencies; reduced sensitivity to color ranges; reduced sensitivity to color ranges such that relative deficiencies or strengths can be attenuated or augmented with color filters; preferential viewing; and/or the like.

Aspects of the invention described herein can be used in other applications apart from assessing visual function(s) of a patient in a medical treatment context. For example, an embodiment can be utilized to provide a distance-related warning or other information to an observer (e.g., patient 14). For example, the observer can be an operator of a vehicle, an individual approaching a restricted area, an individual approaching a place of business, and/or the like. In this case, a changing figure described herein can have feature sizes that can be detected by an individual having a minimum performance level for one or more visual functions at a predetermined distance. In operation, the changing figure will be detected by individuals once they are sufficiently close to the display device (e.g., a traffic light, a traffic sign, a warning light, a vehicle running light, a vehicle brake light, an advertising sign, and/or the like). To this extent, a changing figure described herein can be used in an application to: assess or provide feedback on distance between the observer and the changing figure (e.g., including dynamic variation in the characteristics of the figure in conjunction with velocity of the observer and/or device displaying the changing figure); assess nominal threshold detection of distances between the observer and the changing figure; and/or the like.

While primarily shown and described herein as a method and system for assessing visual function(s) of a patient, it is understood that aspects of the invention further provide various alternative embodiments. For example, in one embodiment, the invention provides a computer program fixed in at least one computer-readable medium, which when executed, enables a computer system to assess visual function(s) of a patient using a process described herein. To this extent, the computer-readable medium includes program code, such as the assessment program 30 (FIG. 1), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as the assessment program 30 (FIG. 1), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for assessing visual function(s) of a patient. In this case, the generating can include configuring a computer system, such as the computer system 20 (FIG. 1), to implement a method of assessing visual function(s) of a patient described herein. The configuring can include obtaining (e.g., creating, maintaining, purchasing, modifying, using, making available, etc.) one or more hardware components, with or without one or more software modules, and setting up the components and/or modules to implement a process described herein. To this extent, the configuring can include deploying one or more components to the computer system, which can comprise one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method comprising:
determining a plurality of shape attributes for a changing figure based on a target visual function, a target performance level of the target visual function, and a plurality of display attributes of a display environment for an observer, wherein the changing figure includes a plurality of contrasting areas;
generating an animation including the changing figure, wherein the generating includes varying the plurality of contrasting areas during the animation to create a substantially continuously changing figure; and
providing the animation for display to the observer.

2. The method of claim 1, wherein the varying creates an appearance of motion within the changing figure in the animation.

3. The method of claim 1, wherein the determining includes selecting a visual arc-area for the plurality of contrasting areas based on a size of a retinal area of the observer to be stimulated.

4. The method of claim 1, further comprising receiving an indication corresponding to an ability of the observer to perceive changes in the appearance of the changing figure.

5. The method of claim 4, further comprising adjusting at least one of the plurality of shape attributes of the changing figure in response to the indication, and repeating the generating and providing using the adjusted plurality of shape attributes.

6. The method of claim 4, further comprising assessing the target visual function using the indication.

7. The method of claim 6, wherein the target visual function is one of: visual acuity, dynamic visual acuity, refraction, distance detection, visual size differentiation, motion detection, color detection, color sensitivity, or contrast sensitivity.

8. The method of claim 1, wherein the varying includes varying at least one of: a visual arc-area, a color, a contrast, a velocity, an acceleration, a size, or a relative size, of the plurality of contrasting areas.

9. A system comprising:
a computer system including at least one computing device, wherein the computer system performs a process for assessing a target visual function including:
determining a plurality of shape attributes for a changing figure based on the target visual function, a target performance level of the target visual function, and a plurality of display attributes of a display environment for an observer, wherein the changing figure includes a plurality of contrasting areas;
generating an animation including the changing figure, wherein the generating includes varying the plurality of contrasting areas during the animation to create a substantially continuously changing figure; and providing the animation for display to the observer.

10. The system of claim 9, the process further comprising receiving an indication corresponding to an ability of the observer to perceive changes in the appearance of the changing figure.

11. The system of claim 10, the process further comprising adjusting at least one of the plurality of shape attributes of the changing figure in response to the indication, and repeating the generating and providing using the adjusted plurality of shape attributes.

12. The system of claim 10, the process further comprising assessing the target visual function using the indication.

13. The system of claim 9, wherein the target visual function is one of: visual acuity, dynamic visual acuity, refraction, distance detection, visual size differentiation, motion detection, color detection, color sensitivity, or contrast sensitivity.

14. The system of claim 9, wherein the varying creates an appearance of motion within the changing figure in the animation.

15. A method comprising:
determining a plurality of shape attributes for a changing figure based on a target visual function, a target performance level of the target visual function, and a plurality of display attributes of a display environment for an observer;
generating an animation including the changing figure, wherein the generating includes creating an appearance of motion within the changing figure, and wherein the changing figure comprises a rectangular shape; and
providing the animation for display to the observer.

16. The method of claim 15, wherein the changing figure includes a plurality of contrasting areas, and wherein the generating includes adjusting a location of the plurality of contrasting areas within the changing figure.

17. The method of claim 16, further comprising determining a second plurality of shape attributes for a second changing figure based on the target visual function, a second target performance level of the target visual function, and the plurality of display attributes, wherein the generating further includes creating an appearance of motion within the second changing figure.

18. The method of claim 15, further comprising:
receiving an indication corresponding to an ability of the observer to perceive changes in the appearance of the changing figure; and
assessing the target visual function using the indication.

19. The method of claim 18, further comprising adjusting at least one of the plurality of shape attributes of the changing figure in response to the indication, and repeating the generating and providing using the adjusted plurality of shape attributes.

20. The method of claim 15, wherein the animation further includes at least one static figure concurrently with the changing figure.
